(19) United States
(12) Patent Application Publication
(10) Pub. No.: US 2011/0268390 A1
(43) Pub. Date: Nov. 3, 2011

(54) ACTIVE OPTICAL CABLE THAT IS SUITED FOR CONSUMER APPLICATIONS AND A METHOD

(75) Inventors: Robert Yi, San Jose, CA (US); Xiaozhong Wang, Sunnyvale, CA (US); Kit Man Cham, Cupertino, CA (US); Paul Yu, Mountain View, CA (US)

(73) Assignee: AVAGO TECHNOLOGIES FIBER IP (SINGAPORE) PTE. LTD., Singapore (SG)

(21) Appl. No.: 12/772,207

(22) Filed: May 1, 2010

(51) Int. Cl. G02B 6/26; G02B 6/36; G02B 6/00

(52) U.S. Cl. 385/50; 385/77; 385/135

(57) ABSTRACT

An active optical cable is provided that is well suited for consumer applications. In contrast to known Quad Small Form-Factor Pluggable (QSFP) active optical cables, the active optical cable incorporates at least one consumer input/output (CIO) optical transceiver module that is well suited for consumer applications. The plug housing of the known QSFP active optical cable has been modified to house at least one CIO optical transceiver module that utilizes laser diode and photodiode singlets, rather than the parallel laser diode and photodiode arrays used in the known QSFP active optical cables. These features reduce the overall cost of the active optical cable and make it well suited for consumer applications.

### TECHNICAL FIELD OF THE INVENTION

The invention relates to active optical cables. More particularly, the invention relates to an active optical cable that is well suited for consumer applications.

### BACKGROUND OF THE INVENTION

An active optical cable is an optical fiber cable that is terminated on one or both ends with a plug that contains an optical transceiver module. The plug has a housing that is typically configured to be received within an opening formed in a cage. Mechanical coupling features on the plug housing form a latch that interlocks with mechanical coupling features on the cage to secure the plug housing to the cage. When the plug housing is fully inserted into the cage, the latch of the plug housing engages one or more of the mechanical coupling features of the cage to lock the plug housing inside of the cage. The latch of the plug housing is typically operable by a user to be placed in a delatching position that decouples the plug housing from the cage to enable the user to remove the plug housing from the cage. For this reason, the latch of the plug housing is sometimes referred to as a “delatch device”, a “delatch mechanism”, or simply as a “delatch”.

FIG. 1 illustrates a top perspective view of a known Quad Small Form-Factor Pluggable (QSFP) active optical cable 2 currently used in the optical communications industry. An optical fiber cable 3 of the QSFP active optical cable 2 includes a plurality of transmit optical fibers (not shown for purposes of clarity) and a plurality of receive optical fibers (not shown for purposes of clarity). The end 3a of the cable 3 is terminated with a plug 4. The plug 4 has a housing 5 in which the aforementioned optical transceiver module (not shown for purposes of clarity) is housed. The plug housing 5 includes a first housing portion 5a and a second housing portion 5b, which are connected together by fastening elements (not shown for purposes of clarity). The first and second portions 5a and 5b of the plug housing 5 are typically made of cast aluminum, cast zinc, or a cast zinc alloy.

A delatch device 6 of the plug 4 allows the plug housing 5 to be delatched from a cage (not shown for purposes of clarity) to enable the plug housing 5 to be removed from the cage. A pull tab 7 is connected on its proximal end 7a to the delatch device 6. When a user pulls on the distal end 7b of the pull tab 7 in the direction indicated by arrow 8, slider portions 6a and 6b of the delatch device 6 move to a limited extent in the direction indicated by arrow 8 (only slider portion 6a can be seen in FIG. 1). This movement of the slider portions 6a and 6b causes outwardly curved ends 6a′ and 6b′ of the slider portions 6a and 6b, respectively, to press against respective catch features on the cage (not shown for purposes of clarity) to allow the plug housing 5 to be retracted from the cage.

The majority of active optical cables currently used in the optical communications industry have configurations that are similar to that of the QSFP active optical cable 2 shown in FIG. 1, although other types of active optical cables of other form factors are also used in the industry. In QSFP active optical cables of the type shown in FIG. 1, the optical transceiver module housed in the plug housing 5 typically includes parallel arrays of vertical cavity surface emitting lasers (VCSELs), parallel arrays of photodiodes, and parallel laser driver and receiver integrated circuit (IC) chips. These parallel components are mounted on an upper surface of a plug printed circuit board (PCB) 9. The parallel components, particularly the VCSEL arrays, are relatively expensive due in large part to the fact that a high degree of uniformity is required among the VCSELs. In addition, the parallel components used in these modules are manufactured in relatively low volumes, and thus generally have higher costs associated with them. Also, the delatch device 6 has a relatively large number of piece parts that also contribute to the higher cost of the active optical cable 2. Specifically, in addition to the delatch device 6 itself, two compression springs (not shown for purposes of clarity) are contained within the plug housing 5 to provide a biasing force that biases the plug 4 in the direction indicated by arrow 8. All of these factors increase the overall cost of these types of active optical cables. Consequently, these types of active optical cables tend to be too costly for consumer applications. For these reasons, currently available active optical cables generally are not well suited for many consumer applications.

A need exists for an active optical cable that can be manufactured at relatively low costs with high quality and that is particularly well suited for consumer applications.

### SUMMARY OF THE INVENTION

The invention is directed to an active optical cable that is well suited for consumer applications and a method for using an active optical cable. The active optical cable comprises an optical fiber cable, a plug, and at least a first consumer input/output (CIO) optical transceiver module. The optical fiber cable has a proximal end, a distal end, at least first and second transmit optical fibers, and at least first and second receive optical fibers. The plug is secured to the proximal end of the optical fiber cable. The plug has a plug housing that has a first housing portion and a second housing portion. The first and second housing portions are secured together to form the plug housing. The first housing portion comprises a cast material and the second housing portion comprises a sheet metal material. The sheet metal material has a wall thickness that is less than a wall thickness of the cast material. The first CIO optical transceiver module is disposed within the plug housing and is connected to proximal ends of the transmit and receive optical fibers. The first CIO module includes at least first and second laser diodes, at least first and second photodiodes, at least a first integrated circuit (IC), and a first optics system module. The first optics system module couples light between respective proximal ends of the first and second transmit optical fibers and the first and second laser diodes, respectively. The first optics system module couples light between respective proximal ends of the first and second receive optical fibers and the first and second the photodiodes, respectively.

The method comprises providing an active optical cable and connecting a plug of the active optical cable to a cage having electrical equipment mounted therein to electrically couple electrical circuitry within the plug with electrical circuitry of the electrical equipment. The active optical cable comprises an optical fiber cable, a plug, and at least a first CIO optical transceiver module. The optical fiber cable has a proximal end, a distal end, at least first and second transmit optical fibers, and at least first and second receive optical fibers. The plug is secured to the proximal end of the optical fiber cable. The plug has a plug housing that has a first housing portion and a second housing portion. The first and second housing portions are secured together to form the plug housing. The first housing portion comprises a cast material and the second housing portion comprises a sheet metal material. The sheet metal material has a wall thickness that is less than a wall thickness of the cast material. The first CIO optical transceiver module is disposed within the plug housing and is connected to proximal ends of the transmit and receive optical fibers. The first CIO module includes at least first and second laser diodes, at least first and second photodiodes, at least a first integrated circuit (IC), and a first optics system module. The first optics system module couples light between respective proximal ends of the first and second transmit optical fibers and the first and second laser diodes, respectively. The first optics system module couples light between respective proximal ends of the first and second receive optical fibers and the first and second the photodiodes, respectively.

These and other features and advantages of the invention will become apparent from the following description, drawings and claims.

### BRIEF DESCRIPTION OF THE DRAWINGS

FIG. 1 illustrates a top perspective view of a known Quad Small Form-Factor Pluggable (QSFP) active optical cable currently used in the optical communications industry.

FIG. 2 illustrates a top perspective view of the active optical cable of the invention in accordance with an illustrative embodiment.

FIG. 3 illustrates a top perspective view of the second housing portion shown in FIG. 2 having first and second CIO optical transceiver modules mounted therein on an upper surface of a plug PCB.

FIG. 5 illustrates a bottom perspective view of the PCB shown in FIG. 4 after laser diodes, photodiodes, and an IC have been mounted on the PCB.

FIG. 6 illustrates a bottom perspective view of the PCB shown in FIG. 5 just prior to an optics system module being mounted on the PCB.

FIG. 7 illustrates a bottom perspective view of the PCB shown in FIG. 6 after the optics system module has been mounted on the PCB just prior to the latch being secured to the optics system module.

FIG. 8 illustrates a bottom perspective view of the PCB shown in FIG. 7 after the latch has been secured to the optics system module.

FIG. 9 illustrates a side cutaway view of a portion of the plug shown in FIG. 2 in which a portion of the plug housing has been removed to reveal a portion of the delatch device located within the plug housing.

### DETAILED DESCRIPTION OF AN EXEMPLARY EMBODIMENT

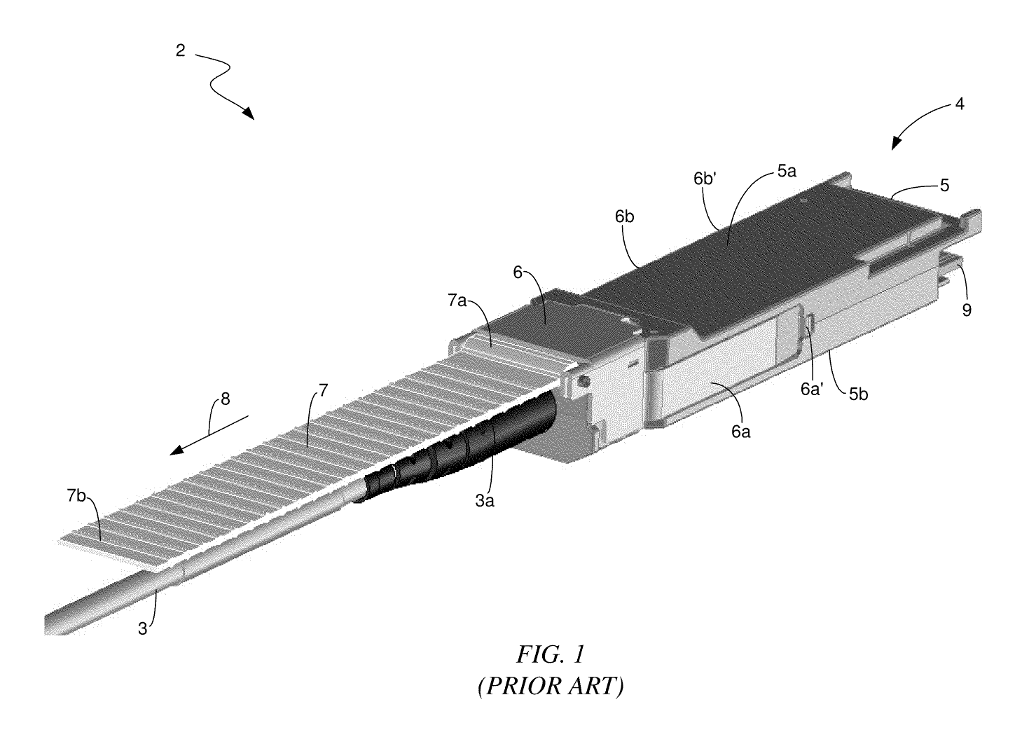

The invention is directed to an active optical cable that is well suited for consumer applications. In contrast to the QSFP active optical cable 2 shown in FIG. 1, the active optical cable of the invention incorporates at least one consumer input/output (I/O) optical transceiver module, hereinafter referred to as a CIO optical transceiver module, that is well suited for consumer applications. In accordance with an exemplary or illustrative embodiment, the plug housing 5 shown in FIG. 1 has been modified to house at least one CIO optical transceiver module. In addition, in contrast to the optical transceiver module of the active optical cable 2 shown in FIG. 1 that utilizes the aforementioned parallel components, the CIO optical transceiver module includes two singlet laser diodes and two singlet photodiodes for providing two transmit channels and two receive channels, respectively. Because the singlet laser diodes and photodiodes of the CIO optical transceiver module are utilized in many areas in the optical communications industry, they are manufactured in relatively large volumes, and thus are less expensive than the parallel arrays of laser diodes and parallel arrays of photodiodes that are used in the active optical cable 2 shown in FIG. 1. For this and other reasons that are described below, the active optical cable of the invention can be manufactured at relatively low costs, and therefore is well suited for consumer applications.

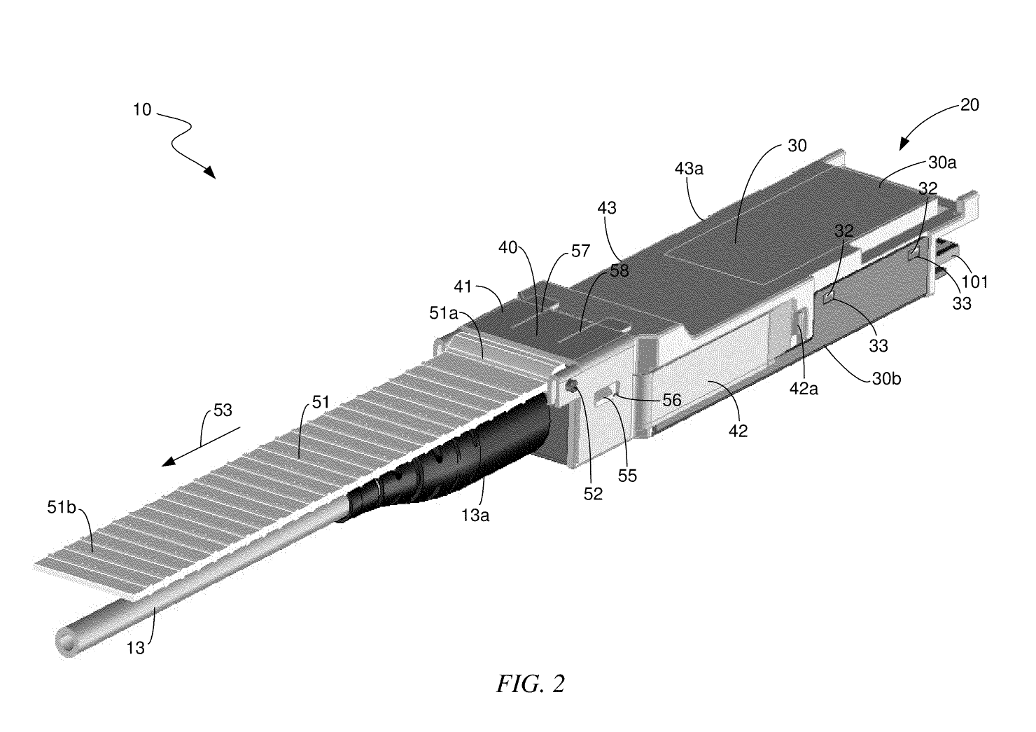

An illustrative embodiment of the active optical cable will now be described with reference to FIGS. 2-9. It should be noted, however, that the invention is not limited to the illustrative embodiment described below and that many variations may be made to the embodiment described below without deviating from the invention. Persons skilled in the art will understand the manner in which modifications may be made to the active optical cable described below and that all such modifications are within the scope of the invention.

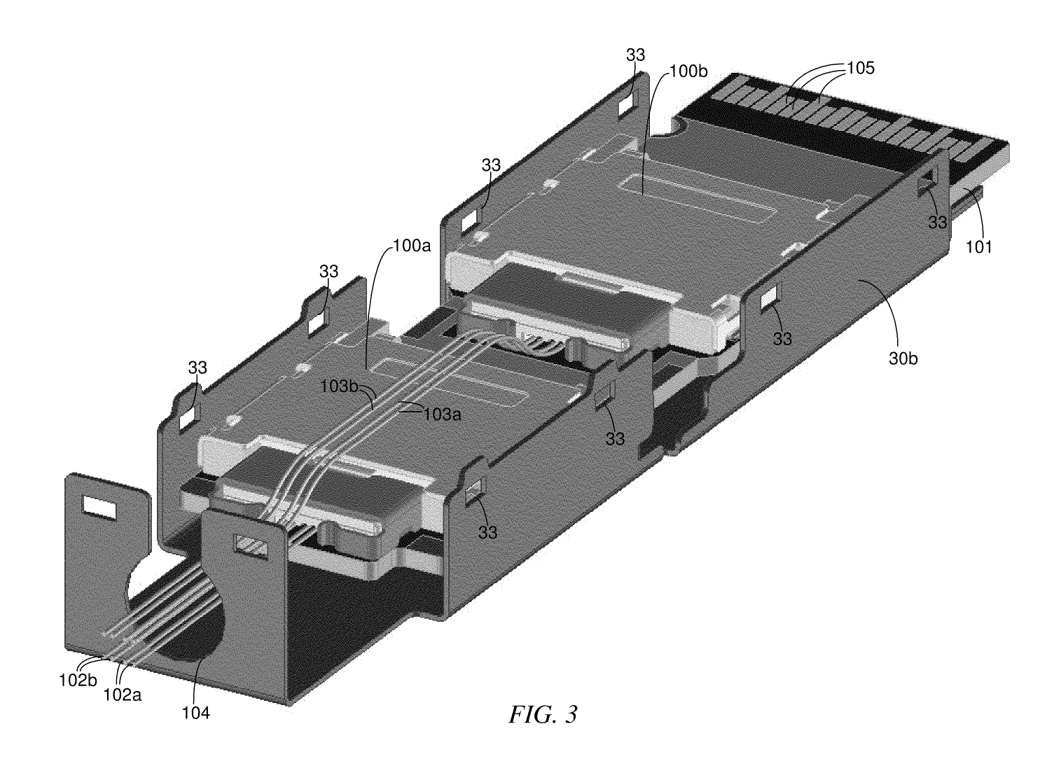

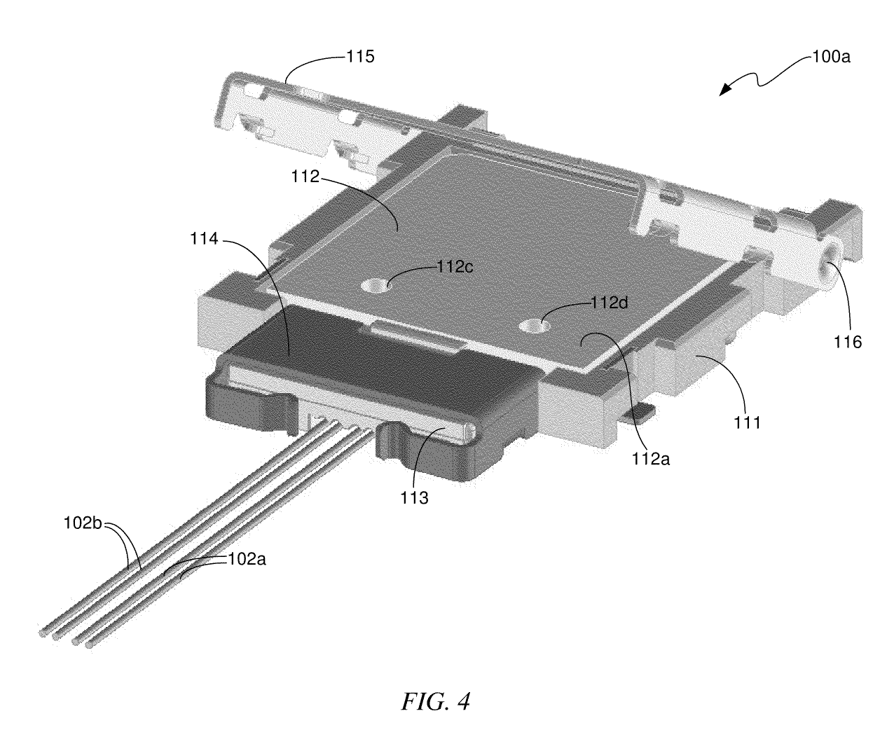

FIG. 2 illustrates a top perspective view of the active optical cable 10 in accordance with an illustrative embodiment. The active optical cable 10 includes an optical fiber cable 13 that is terminated on at least one end 13a with a plug 20. The optical fiber cable 13 includes a plurality of transmit optical fibers (not shown for purposes of clarity) and a plurality of receive optical fibers (not shown for purposes of clarity). The plug 20 has a plug housing 30 that houses at least one CIO optical transceiver module (not shown for purposes of clarity), as will be described below in detail with reference to FIGS. 3-8. In accordance with this embodiment, the plug housing 5 shown in FIG. 1 has been modified to provide additional space within the housing to accommodate the components of the CIO optical transceiver module. As indicated above with reference to FIG. 1, the first and second housing portions 5a and 5b of the plug housing 5 shown in FIG. 1 are typically made of a cast material, such as cast aluminum, cast zinc, or a cast zinc alloy. Because of the nature of the casting process that is used to create the first and second housing portions 5a and 5b, the wall thickness of the first and second housing portions 5a and 5b is typically greater than 0.5 millimeters (mm) in thickness. Consequently, there is insufficient space within the housing 5 to accommodate the components of a CIO optical transceiver module that incorporates singlet laser diodes and singlet photodiodes.

In accordance with this embodiment, the plug housing 30 has a first housing portion 30a that is cast (e.g., cast aluminum, cast zinc, or a cast zinc alloy) and a second housing portion 30b that is made of sheet metal. Thus, the first housing portion 30a is very similar to the first housing portion 6a shown in FIG. 1, except that various modifications have been made to the first housing portion 30a to allow it to mechanically couple with the sheet metal second housing portion 30b, as will be described below in more detail. Because sheet metal can be made very thin, the use of sheet metal to make the second housing portion 30a decreases the wall thickness of the second housing portion 30b, thereby increasing the amount of space that is available within the plug housing 30 to accommodate the components of the CIO optical transceiver module, as will be described below in detail with reference to FIG. 3. In this manner, the plug 20 complies with one or more small form factor (SFF) standards, such as the SFF-8436 standard, for example.

Tabs 32 formed on the sides of the first housing portion 30a are configured to snap fit into respective openings 33 formed in the sides of the second housing portion 30b to secure the second housing portion 30b to the first housing portion 30a. A delatch device 40 of the plug 20 allows a user to delatch the plug 20 from a cage (not shown for purposes of clarity) to enable the plug 20 to be removed from the cage. The delatch device 40 has a configuration that is different from the configuration of the delatch device 6 shown in FIG. 1. The delatch device 40 has a part count that is less than the part count of the delatch device 6 shown in FIG. 1, which allows the delatch device 40 to be manufactured at a cost that is less than that of the delatch device 6. This helps reduce the overall cost of the active optical cable 10.

The delatch device 40 includes a first delatch portion 41 and first and second slider portions 42 and 43 (only slider portion 42 can be seen in FIG. 2). The slider portions 42 and 43 may be identical to the slider portions 6a and 6b, respectively, of the delatch device 6 shown in FIG. 1. Likewise, the manner in which the slider portions 42 and 43 interact with features on a cage to disconnect the plug housing 30 from the cage may be identical to the manner described above with reference to FIG. 1 in which the slider portions 6a and 6b of the delatch device 6 interact with features on a cage to disconnect the plug housing 5 from the cage.

A pull tab 51 is connected on its proximal end 51a to the delatch device 40 by fastening devices 52. When a user pulls on the distal end 51b of the pull tab 51 in the direction indicated by arrow 53, the delatch device 40 moves to a limited extent in the direction indicated by arrow 53. This movement of the delatch device 40 causes the slider portions 42 and 43 of the delatch device 40 to move to a limited extent in the direction indicated by arrow 53. Tabs 55 located on opposite sides of the first housing portion 30a move within respective slots 56 located on opposite sides of the first delatch portion 41 to limit movement by the delatch device 40 relative to the first housing portion 30a. This movement of the slider portions 42 and 43 causes outwardly curved ends 42a and 43a of the slider portions 42 and 43, respectively, to press against respective catch features on the cage (not shown for purposes of clarity) to allow the plug 20 to be retracted from the cage.

FIG. 3 illustrates a top perspective view of the second housing portion 30b shown in FIG. 2 having first and second CIO optical transceiver modules 100a and 100b mounted therein on a first surface of a plug PCB 101. The plug PCB 101 may be identical to the plug PCB 9 shown in FIG. 1 except that the configuration of the electrical traces running through plug PCB 101 will typically be different from the configuration of the electrical traces running through the plug PCB 9 due to the differences between the types of components that are mounted on the plug PCBs 9 and 101. The plug PCB 101 has electrical contacts 105 thereon for electrically coupling the plug PCB 101 to electrical circuitry of external equipment into which the plug 20 is plugged (not shown for purposes of clarity).

The end 13a of the optical fiber cable 13 is received in opening 104 provided in the second housing portion 30b. Two transmit optical fibers 102a and two receive optical fibers 102b pass out of the end 13a of the optical fiber cable 13 and are connected to the first CIO optical transceiver module 100a. Likewise, two transmit optical fibers 103a and two receive optical fibers 103b pass out of the end 13a of the optical fiber cable 13 and are connected to the second CIO optical transceiver module 100b. The first and second CIO optical transceiver modules 100a and 100b have identical mechanical, optical and electrical configurations. Although the CIO optical transceiver modules 100a and 100b are not limited to operating at any particular data rates, in accordance with this illustrative embodiment, each CIO optical transceiver module 100a and 100b has two 10 Gigabits per second (Gbps) transmit channels and two 10 Gbps receive channels. Thus, each of the CIO optical transceiver modules 100a and 100b has an aggregate data rate of 40 Gbps, i.e., 20 Gbps in and 20 Gbps out, simultaneously. It should be noted that although two CIO optical transceiver modules 100a and 100b are shown in FIG. 3, more than two and as few as one CIO optical transceiver module may be incorporated into the plug 20 of the active optical cable 10.

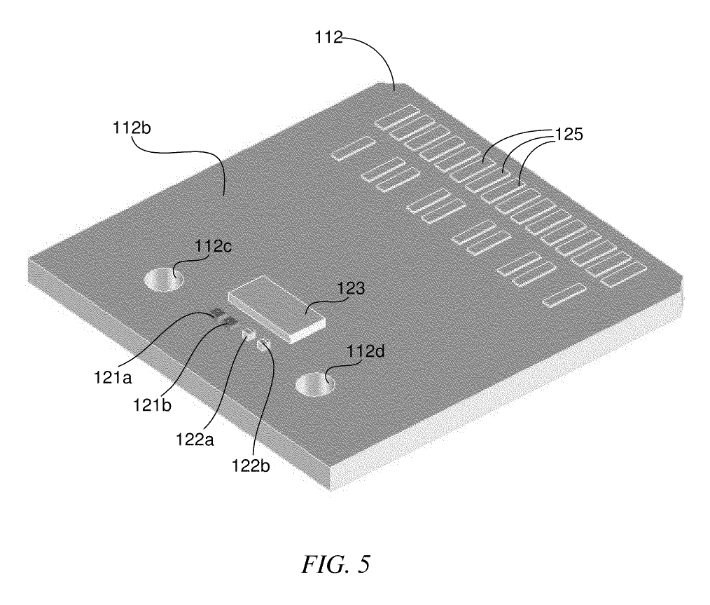

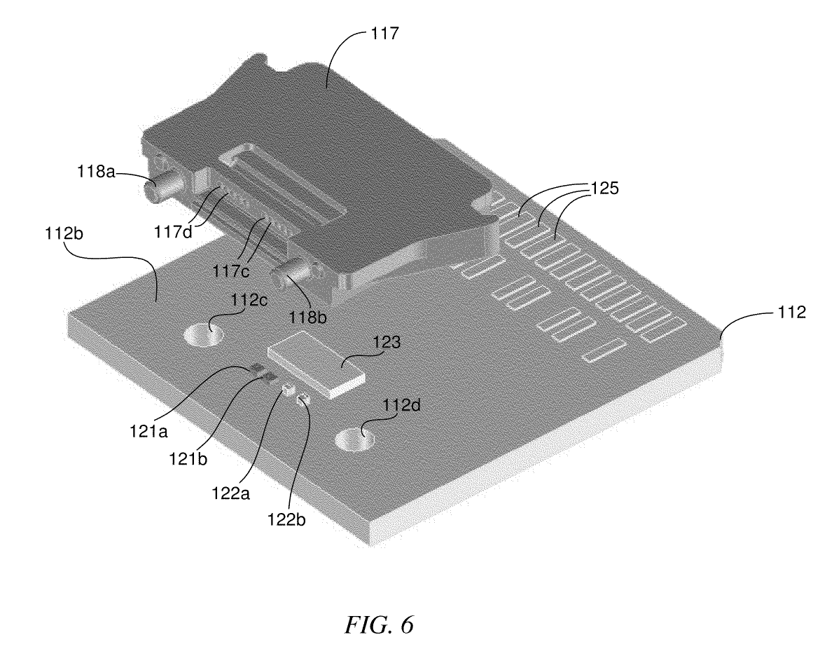

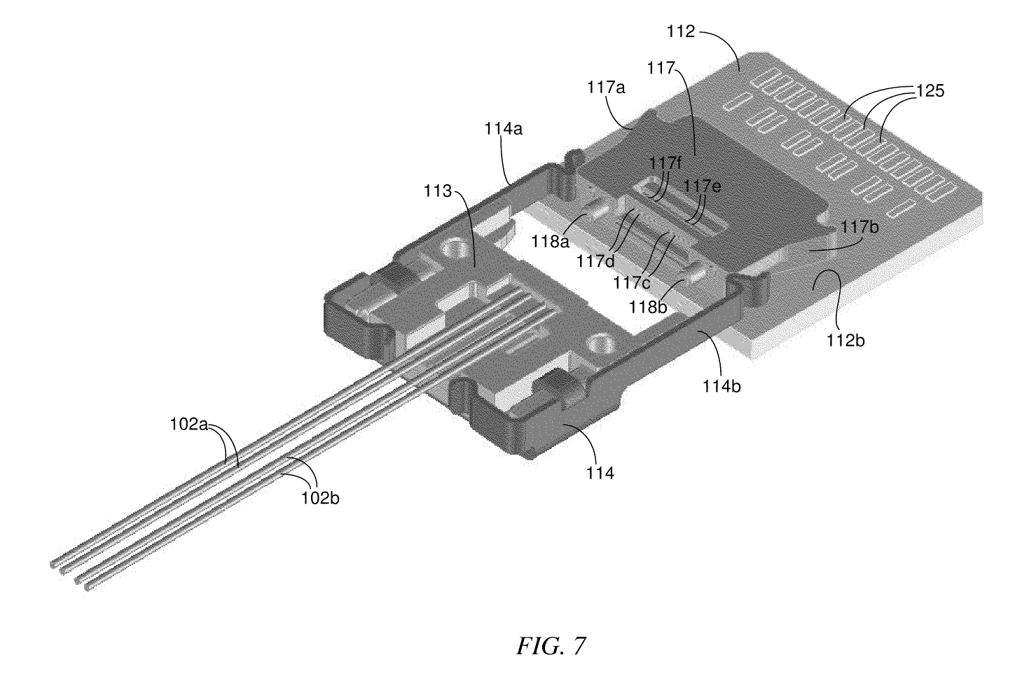

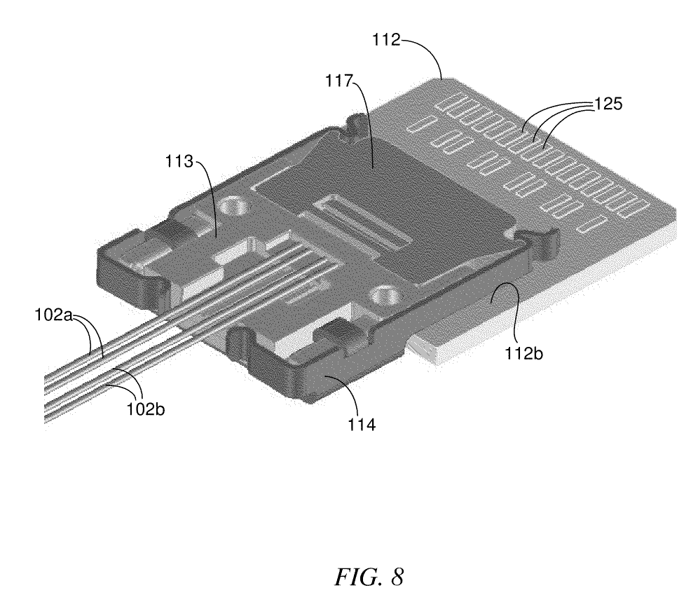

The components and assembly of the first CIO optical transceiver module 100a will now be described with reference to FIGS. 4-8. FIG. 4 illustrates a top perspective view of the first CIO optical transceiver module 100a. A socket 111 of the module 100a receives a PCB 112 of the module 100a. A jumper 113 of the module 100a holds the proximal ends of the transmit and receive optical fibers 102a and 102b. A latch 114 of the module 100a holds the jumper 113. A socket cover 115 is rotationally coupled to the socket 111 via coupling features 116 to allow the cover 115 to be placed in an opened position (shown in FIG. 4) and in a closed position (not shown for purposes of clarity). FIG. 5 illustrates a bottom perspective view of the PCB 112 shown in FIG. 4 after first and second laser diodes 121a and 121b, first and second photodiodes 122a and 122b, and an IC 123 have been mounted on the PCB 112. FIG. 6 illustrates a bottom perspective view of the PCB 112 shown in FIG. 5 just prior to an optics system module 117 being mounted on the PCB 112. FIG. 7 illustrates a bottom perspective view of the PCB 112 shown in FIG. 6 after the optics system module 117 has been mounted on the PCB 112 just prior to the latch 114 being secured to the optics system module 117. FIG. 8 illustrates a bottom perspective view of the PCB 112 shown in FIG. 7 after the latch 114 has been secured to the optics system module 117.

The first and second laser diodes 121a and 121b, respectively, and the first and second photodiodes 122a and 122b, respectively, are mounted on a lower surface 112b of the module PCB 112. The laser diodes 121a and 121b may be, but need not be, VCSELs. The photodiodes may be, but need not be, P-I-N diodes. As indicated above, in contrast to the optical transceiver module of the active optical cable 2 shown in FIG. 1, which utilizes the aforementioned parallel arrays of laser diodes and parallel arrays of photodiodes, the CIO optical transceiver module includes two singlet laser diodes and two singlet photodiodes for providing two transmit channels and two receive channels, respectively. Because the singlet laser diodes and photodiodes of the CIO optical transceiver module are utilized in many areas in the optical communications industry, they are typically manufactured in relatively large volumes, and thus are less expensive than the parallel arrays of laser diodes and parallel arrays of photodiodes that are used in the active optical cable 2 shown in FIG. 1. This feature helps lower the cost of the active optical cable 10 so that it is better suited for consumer applications than the active optical cable 2 shown in FIG. 1. It should be noted, however, that the invention is not limited to using only singlet laser diodes and photodiodes in the optical transceiver module.

The IC 123 is also mounted on the lower surface 112b of the module PCB 112. The IC 123 includes laser diode driver circuitry and receiver circuitry (not shown for purposes of clarity) for performing a combination of laser diode driver functions and receiver functions. The module PCB 112 has openings 112c and 112d formed therein for mating with respective protrusions (not shown for purposes of clarity) formed on the optics system module 117 to allow the optics system module 117 to be secured to the lower surface 112b of the module PCB 112. The module PCB 112 has a plurality of electrical contacts 125 thereon for electrically coupling the module PCB 112 to electrical contacts (not shown for purposes of clarity) of the plug PCB 101 (FIG. 3).

The optics system module 117 has protrusions 118a and 118b thereon that mate with respective openings (not shown for purposes of clarity) formed in the jumper 113 to optically align the optics system module 117 with the jumper 113. The sides 114a and 114b of the latch 114 are configured as spring elements that have shapes that are complementary to the shapes of the sides 117a and 117b, respectively, of the optics system module 117 to allow the latch 114 to snap fit onto the optics system module 117. When the latch 114 is secured to the optics system module 117 in this manner, the protrusions 118a and 118b are mated with the respective openings formed in the jumper 113 to optically align the jumper 113 with the optics system module 117.

The optics system module 117 has lenses 117c and 117d formed therein. The lenses 117c optically couple light between the proximal ends of the two transmit optical fibers 102a and the respective laser diodes 121a and 121b. The lenses 117d optically couple light between the proximal ends of the two receive optical fibers 102b and the photodiodes 122a and 122b. The optics system module 117 has 45° mirrors 117e and 117f therein that optically couple light between the lenses 117c and the photodiodes 122a, 122b and between the lenses 117d and the laser diodes 121a, 121b. In the embodiment shown in FIG. 7, more than four lenses 117c and 117d are shown in the optics system module 117. The additional lenses are not necessary, but allow for the possibility of accommodating configurations of the CIO optical transceiver module 100a that have more than two transmit and two receive channels.

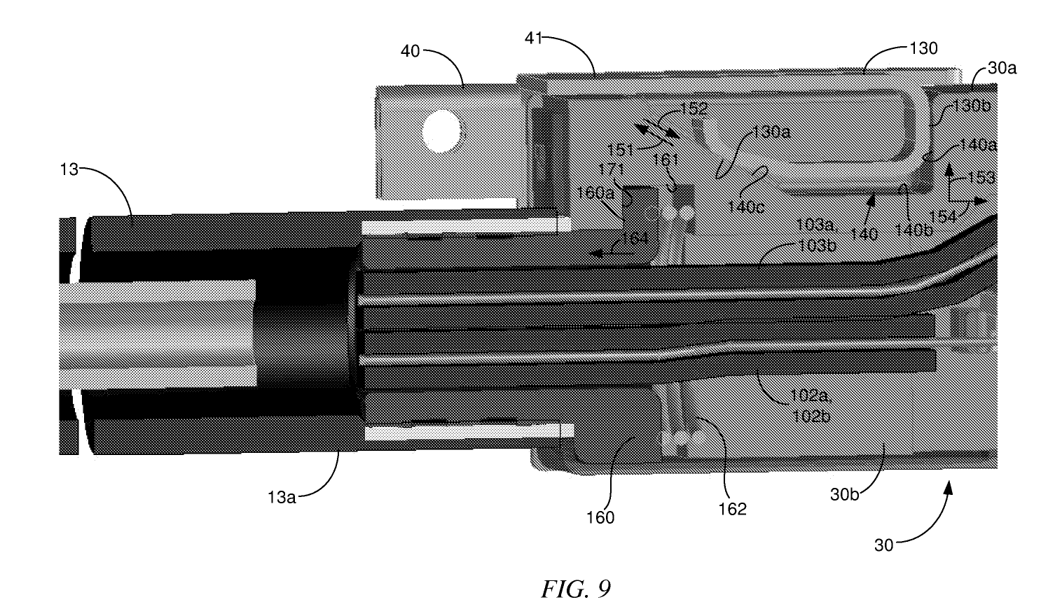

FIG. 9 illustrates a side cutaway view of a portion of the plug 20 shown in FIG. 2 in which a portion of the plug housing 30 has been removed to reveal a portion of the delatch device 40 located within the plug housing 30. With reference to FIGS. 2 and 9, the first delatch portion 41 has slots 57 and 58 formed therein to allow a cantilever spring arm 130 having a curled, or folded, shape to be formed in the delatch device 30. The cantilever spring arm 130 is received within a recess 140 formed in the first housing portion 30a of the plug housing 30. The recess 140 is defined by a first side 140a, a second side 140b and a third side 140c. The first and second sides 140a and 140b are generally perpendicular to one another. The third side 140c is a ramped surface over which a lower portion 130a of the cantilever spring arm 130 travels.

As stated above, the delatch device 40 has a smaller number of piece parts than the delatch device 6 shown in FIG. 1. Specifically, the delatch device 40 utilizes a single cantilever spring arm 130 whereas the delatch device 6 uses two compression springs (not shown for purposes of clarity). The reduction in the number of piece parts reduces the cost of the delatch device 40, which reduces the overall cost of the active optical cable 10. When the end 51b of the pull tab 51 (FIG. 2) is pulled in the direction indicated by arrow 53 (FIG. 2), the lower portion 130a of the cantilever spring arm 130 bends inwardly as it slides in the direction of arrow 151 along the ramped surface 140c. When the end 51b of the tab 51 is released, the force of the cantilever spring arm 130 against the ramped surface 140c attempts to push the cantilever spring arm 130 in the directions indicated by arrows 153 and 154. However, because the slots 56 (FIG. 2) formed on the sides of the delatch device 40 limit the direction of movement of the tabs 55 (FIG. 2) formed on the first housing portion 30a to the lateral directions of the slots 56, the cantilever spring arm 130 moves in the direction indicated by arrow 154 until a portion 130b of the cantilever spring arm 130 rests against the first surface 140b of the recess 140. The spring force of the cantilever spring arm 130 is at a minimum when the cantilever spring arm 130 is in the latter at-rest position.

With reference again to FIGS. 2 and 3, the first housing portion 30a and the second housing portion 30b overlap over a relatively large interface above, below, and along locations around where the tabs 32 formed on the first housing portion 30a are received in the respective openings 33 formed on the second housing portion 30b. This relatively large area of overlap provides a Faraday cage that provides electromagnetic interference (EMI) shielding for components within the plug housing 30. Additionally, the invention eliminates the need to use traditional solutions such as silver epoxy along the seams, which allows the plug 20 to be more easily reworked if necessary, which, in turn, allows manufacturing costs to be reduced and manufacturing yield to be increased.

With reference to FIGS. 3 and 9, in order to provide EMI shielding for the opening 104 provided in the second housing portion 30b for receiving the cable end 13a, the plug housing 30 includes a strain relief device 160 that surrounds portions of the optical fibers 102a-103b adjacent to cable end 13a and is connected to cable end 13a and to the first and second housing portions 30a and 30b. The strain relief device 160 is made of a metal material so that it performs a dual function of EMI shielding and relieving strain for the optical fibers 102a-103b. A portion 160a of the strain relief device 160 is contained within a slot 161 formed in the plug housing 30. The slot 161 is generally cylindrical in shape and surrounds the optical fibers 102a-103b. Within the slot 161, a compression spring 162 is disposed for biasing the portion 160a of the strain relief device 160 in the direction indicated by arrow 164 such that the portion 160a of the strain relief device 160 remains in continuous contact with a portion 171 of the first housing portion 30a. In this way, the portion 160a of the strain relief device 160 seals the opening 104 to provide EMI shielding at the opening 104. This obviates the need to use a silver epoxy strain relief solution for EMI shielding, as is typically used in the plug housing 5 shown in FIG. 1. It should be noted that springs other than the compression spring 162 may be used for this purpose. For example, a sheet metal spring may be used in place of the compression spring 162.

In can be seen from the above description of the illustrative embodiment depicted in FIGS. 2-9 that active optical cable 10 of the invention has several advantages over the known active optical cable 2 shown in FIG. 1. Modification of the plug housing 5 in the manner described above to create plug housing 30 allows one or more of the CIO optical transceiver modules to be disposed within the plug housing 30. Eliminating the use of parallel arrays of VCSELs and parallel arrays of photodiodes in the optical transceiver module reduces the overall costs of the active optical cable 10, and yet the active optical cable 10 is capable of operating at high data rates. Reducing the number of piece parts that make up the delatch device 40 also reduces the overall cost of the active optical cable 10. In addition, the plug housing 30 implements a highly effective EMI shielding solution. Furthermore, the active optical cable 10, in accordance with the illustrative embodiment, is designed to ensure that it meets one or more applicable SFF standards. Also, because the same CIO optical transceiver module 100a, 100b can be used with different form factors (e.g., SFP, QSFP, CFP, CXP, etc.), a volume cost savings can be achieved, which further reduces the overall cost of the active optical cable 10. The combination of these features results in the active optical cable 10 being well suited for consumer applications. It should be noted, however, that while the active optical cable 10 is well suited for consumer applications, it is not limited to use in consumer applications, as will be understood by persons of ordinary skill in the art.

It should be noted that the invention has been described with reference to illustrative embodiments and that the invention is not limited to these embodiments. Those skilled in the art will understand the manner in which modifications can be made to the illustrative embodiments and that all such modifications are within the scope of the invention. For example, although the plug housing 30, the delatch device 40 and the CIO optical transceiver modules 100a, 100b have been described as having particular configurations, persons skilled in the art will understand the manner in which these configurations may be modified while still achieving the goals of the invention. These and other modifications may be made to the embodiments described herein and all such modified embodiments are also within the scope of the invention, as will be understood by persons skilled in the art.

1. An active optical cable comprising:
an optical fiber cable having a proximal end, a distal end, at least first and second transmit optical fibers, and at least first and second receive optical fibers;
a plug secured to the proximal end of the optical fiber cable, the plug having a plug housing, the plug housing having a first housing portion and a second housing portion, wherein the first and second housing portions are secured together to form the plug housing, the first portion comprising a cast material and the second housing portion comprising a sheet metal material, the sheet metal material having a wall thickness that is less than a wall thickness of the cast material, wherein first side walls of the first housing portion overlap and are internal to first side walls of the second housing portion, and wherein second side walls of the first housing portion overlap and are internal to second side walls of the second housing portion, the overlap of the side walls providing the plug housing with electromagnetic interference (EMI) shielding; and
at least a first consumer input/output (CIO) optical transceiver module disposed within the plug housing and connected to proximal ends of the transmit and receive optical fibers, the first CIO module including at least first and second laser diodes, at least first and second photodiodes, at least a first integrated circuit (IC), and a first optics system module, the first optics system module coupling light between respective proximal ends of the first and second transmit optical fibers and the first and second laser diodes, respectively, the first optics system module coupling light between respective proximal ends of the first and second receive optical fibers and the first and second the photodiodes, respectively.

2. The active optical cable of claim 1, wherein the plug housing is compliant with at least one known Quad Small Form-Factor Pluggable (QSFP) active optical cable standard.

3. The active optical cable of claim 2, wherein the plug housing is a modified known QSFP plug housing, wherein at least one modification to the QSFP plug housing that has been made is to replace a lower housing portion of a known QSFP plug housing that comprises a cast material with said second housing portion comprising the sheet metal material.

4. The active optical cable of claim 3, wherein the first and second laser diodes are singlet laser diodes and wherein the first and second photodiodes are singlet photodiodes.

5. (canceled)

6. The active optical cable of claim 1, further comprising:
a delatch device secured to the plug housing and operable to be placed in a latched position when the plug housing is fully inserted within an opening of a cage and operable to be placed in a delatched position that allows the plug housing to be delatched and removed from the cage, the delatch device comprising sheet metal material, and wherein the delatch device includes a cantilever spring arm comprising a curled portion of the sheet metal material of the delatch device, and wherein the first housing portion has a recess formed therein for receiving the cantilever spring arm, the recess including a ramped surface along which a portion of the cantilever spring arm travels if the delatch device is placed in the delatched position subsequent to being placed in the latched position.

7. The active optical cable of claim 1, wherein the optical fiber cable further comprises at least third and fourth transmit optical fibers, and at least third and fourth receive optical fibers, and wherein the active optical cable further comprises:
at least a second CIO optical transceiver module disposed within the plug housing and connected to proximal ends of the third and fourth transmit optical fibers and the third and fourth receive optical fibers, the second CIO module including at least third and fourth laser diodes, at least third and fourth photodiodes, at least a second IC, and a second optics system module, the second optics system module coupling light between respective proximal ends of the third and fourth transmit optical fibers and the third and fourth laser diodes, respectively, the second optics system module coupling light between respective proximal ends of the third and fourth receive optical fibers and the third and fourth the photodiodes, respectively.

8. The active optical cable of claim 1, wherein the third and fourth laser diodes are singlet laser diodes and wherein the third and fourth photodiodes are singlet photodiodes.

9. The active optical cable of claim 1, wherein the plug housing further comprises:
a strain relief device having a first portion that is secured within a slot formed in the plug housing and having a second portion that is secured to the proximal end of the optical fiber cable, the strain relief device relieving strain on the transmit and receive optical fibers, and wherein the strain relief device comprises a metal material that performs an electromagnetic interference (EMI) shielding function, the slot formed in the plug housing having a spring therein for biasing the first portion of the strain relief device into contact with a portion of the plug housing that defines the slot.

10. A method for using an active optical cable for communicating optical signals, the method comprising:
providing an active optical cable having an optical fiber cable, a plug, and at least a first consumer input/output (CIO) optical transceiver module, the optical fiber cable having a proximal end, a distal end, at least first and second transmit optical fibers, and at least first and second receive optical fibers, the plug being secured to the proximal end of the optical fiber cable, the plug having a plug housing having a first housing portion and a second housing portion, wherein the first and second housing portions are secured together to form the plug housing, the first portion comprising a cast material and the second housing portion comprising a sheet metal material, the sheet metal material having a wall thickness that is less than a wall thickness of the cast material, wherein first side walls of the first housing portion overlap and are internal to first side walls of the second housing portion, and wherein second side walls of the first housing portion overlap and are internal to second side walls of the second housing portion, the overlap of the side walls providing the plug housing with electromagnetic interference (EMI) shielding, wherein the first CIO optical transceiver module being disposed within the plug housing and connected to proximal ends of the transmit and receive optical fibers, the first CIO module including at least first and second laser diodes, at least first and second photodiodes, at least a first integrated circuit (IC), and a first optics system module, the first optics system module coupling light between respective proximal ends of the first and second transmit optical fibers and the first and second laser diodes, respectively, the first optics system module coupling light between respective proximal ends of the first and second receive optical fibers and the first and second the photodiodes, respectively; and
connecting the plug to a cage having electrical equipment mounted therein to electrically couple electrical circuitry within the plug housing with electrical circuitry of the electrical equipment.

11. The method of claim 10, wherein the plug housing is compliant with at least one known Quad Small Form-Factor Pluggable (QSFP) active optical cable standard.

12. The method of claim 11, wherein the plug housing is a modified known QSFP plug housing, wherein at least one modification to the QSFP plug housing that has been made is to replace a lower housing portion of the known QSFP plug housing that comprises a cast material with said second housing portion comprising the sheet metal material.

13. The method of claim 10, wherein the first and second laser diodes are singlet laser diodes and wherein the first and second photodiodes are singlet photodiodes.

14. (canceled)

15. The method of claim 10, wherein the active optical cable further comprises a delatch device secured to the plug housing and operable to be placed in a latched position when the plug housing is fully inserted within an opening of a cage and operable to be placed in a delatched position that allows the plug housing to be delatched and removed from the cage, the delatch device comprising sheet metal material, and wherein the delatch device includes a cantilever spring arm comprising a curled portion of the sheet metal material of the delatch device, and wherein the first housing portion has a recess formed therein for receiving the cantilever spring arm, the recess including a ramped surface along which a portion of the cantilever spring arm travels if the delatch device is placed in the delatched position subsequent to being placed in the latched position.

16. The method of claim 10, wherein the optical fiber cable further comprises at least third and fourth transmit optical fibers, and at least third and fourth receive optical fibers, and wherein the active optical cable further comprises at least a second CIO optical transceiver module disposed within the plug housing and connected to proximal ends of the third and fourth transmit optical fibers and the third and fourth receive optical fibers, the second CIO module including at least third and fourth laser diodes, at least third and fourth photodiodes, at least a second IC, and a second optics system module, the second optics system module coupling light between respective proximal ends of the third and fourth transmit optical fibers and the third and fourth laser diodes, respectively, the second optics system module coupling light between respective proximal ends of the third and fourth receive optical fibers and the third and fourth the photodiodes, respectively.

17. The method of claim 16, wherein the third and fourth laser diodes are singlet laser diodes and wherein the third and fourth photodiodes are singlet photodiodes.

18. The method of claim 10, wherein the plug housing further comprises a strain relief device having a first portion that is secured within a slot formed in the plug housing and having a second portion that is secured to the proximal end of the optical fiber cable, the strain relief device relieving strain on the transmit and receive optical fibers, and wherein the strain relief device comprises a metal material that performs an electromagnetic interference (EMI) shielding function, the slot formed in the plug housing having a spring therein for biasing the first portion of the strain relief device into contact with a portion of the plug housing that defines the slot.
